(19) United States
(12) Patent Application Publication
(10) Pub. No.: US 2017/0009659 A1
(43) Pub. Date: Jan. 12, 2017

(54) COOLING OF A MAIN LINE IN A MULTIPOINT FUEL INJECTION SYSTEM

(71) Applicant: SAFRAN AIRCRAFT ENGINES, Paris (FR)

(72) Inventors: Sebastien CHALAUD, Moissy-Cramayel Cedex (FR); Olivier Robert Michel DELEPIERRE-MASSUE, Moissy-Cramayel Cedex (FR)

(21) Appl. No.: 15/118,065

(22) PCT Filed: Feb. 10, 2015
(86) PCT No.: PCT/FR2015/050327

§ 371 Date: Aug. 10, 2016

(30) Foreign Application Priority Data
Feb. 12, 2014 (FR) 1451070

(51) Int. Cl. F02C 7/22; F23R 3/34; F02C 7/14; F23R 3/28

(52) U.S. Cl. CPC F02C 7/222; F23R 3/283; F23R 3/343; F02C 7/14; F23R 2900/00004; F05D 2220/32; F05D 2260/232; F05D 2300/5024

(57) ABSTRACT

The invention relates to a fuel system (1) for a turbine engine, adapted for injecting fuel in a combustion chamber (5) of the turbine engine, comprising:
a pilot circuit (10), adapted for injecting fuel in the combustion chamber (5) by means of a pilot pipe (14),
a main circuit (20), adapted for injecting fuel in the combustion chamber (5) by means of a main pipe (24),
   the fuel system (1) being characterized in that it also comprises a thermal conductor (30) confined between the pilot pipe (14) and the main pipe (24) and configured to direct the thermal flow from the main pipe (24) to the pilot pipe (14).

### FIELD OF THE INVENTION

The present invention relates to the field of turbine engine fuel systems, aircraft in particular, and more particularly relates to fuel injection systems in these combustion chambers.

The invention relates more precisely to injection systems with dual circuit fuel injection, which comprise a central nozzle, currently called pilot nozzle, delivering a permanent fuel flow rate optimised for low speeds, as well as a peripheral nozzle, sometimes called main nozzle, which delivers an intermittent fuel flow rate optimised for high speeds. These injection systems have been developed for improved adaptation of the injection of air and fuel at different operating speeds of combustion chambers to reduce their emission of pollutants such as nitrogen oxides and fumes.

### TECHNOLOGICAL BACKGROUND

The fuel system can comprise a set of fuel injectors disposed in the combustion chamber, a fuel pump for pressurising fuel from the fuel tank, a fuel metering unit (FMU) for metering the quantity of fuel to the injectors, and a fuel supply circuit fluidically connecting the fuel metering unit to the fuel injectors.

The combustion chambers in a low NOx emission need to be able to distribute fuel injected between at least two injection pipes, a pilot pipe and a main pipe, so as to adjust the rate of the injectors as a function of the flight phase and improve the homogeneity of the air/fuel mixture and therefore combustion, which reduces the rate of pollutants.

For this reason, the fuel system can comprise many flow paths, typically two series of injectors (main and pilot), pipes for each series and a rate division valve (also known under the term “split valve”) arranged downstream of the metering unit.

In such systems, the fuel is delivered to the pilot and main injectors as a function of operability laws of the turbine engine. For example, during startup of the turbine engine the fuel is initially provided to the pilot injectors only.

Since the main pipe is at an intermittent flow, the fuel it contains can remain stagnating for long periods, typically from twenty minutes to one hour. During these periods, the stagnating fuel therefore undergoes a severe environment, especially in temperature, the consequence of which is the rise in temperature of fuel stagnating in the main pipe and therefore the risk of formation of coke, which can obstruct the main injectors located downstream of these pipes.

To prevent the formation of coke in the main pipes, air could be drawn off upstream of the fuel system to cool the main pipes. Yet it eventuates that this solution has an impact on the performance of the turbine engine.

### SUMMARY OF THE INVENTION

An aim of the invention is to propose a fuel system, especially for an aircraft turbine engine, comprising at least two fuel supply pipes configured to inject fuel in the combustion chamber as a function of the speed of the turbine engine, limiting or even preventing, efficaciously and simple to manage, the coking of fuel likely to stagnate in the injection pipes.

For this, the invention proposes a fuel system for a turbine engine, adapted for injecting fuel in a combustion chamber of the turbine engine, comprising:

a pilot circuit, adapted for injecting fuel in the combustion chamber by means of a pilot pipe,

a main circuit, adapted for injecting fuel in the combustion chamber by means of a main pipe,

the fuel system being characterized in that it further comprises a thermal conductor confined between the pilot pipe and the main pipe and configured to direct the thermal flow of the main pipe to the pilot pipe.

Some preferred, though non-limiting, characteristics of the fuel system described hereinabove are the following:

the thermal conductor is housed in an envelope, said envelope being placed around the pilot pipe and the main pipe,

the envelope is formed of insulating material which can have a thickness comprised between around 1 mm and around 40 mm, preferably between 1 mm and 10 mm, for example of the order of 3 mm,

the thermal conductor comprises a heat-transfer fluid,

the heat-transfer fluid is air,

the thermal conductor comprises a thermally conductive material in the solid state,

the thermally conductive material has thermal conductivity greater than that of air,

the thermally conductive material comprises rubber, and

the thermal conductor extends over all or part of the length of the main pipe upstream of the combustion chamber.

The invention also proposes a turbine engine comprising a fuel system as described hereinabove.

### BRIEF DESCRIPTION OF THE DRAWINGS

Other characteristics, aims and advantages of the present invention will emerge more clearly from the following detailed description and with respect to the appended drawings given by way of non-limiting examples and in which:

FIG. 1 is a partial view of an embodiment of a thermal conductor in the solid state confined between a main pipe and a pilot pipe,

FIG. 2 is a partial view of another embodiment of a thermal conductor housed in an insulating envelope and confined between a main pipe and a pilot pipe, the insulating envelope having been partially cut to display the passage of the thermal flows,

FIG. 3 schematically shows an example of fuel system as per the invention.

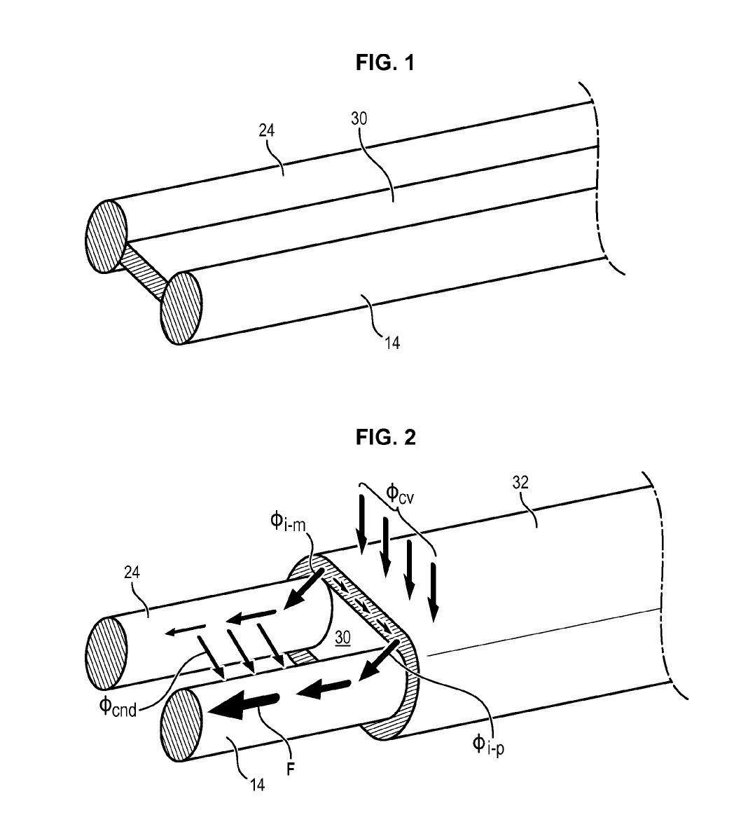

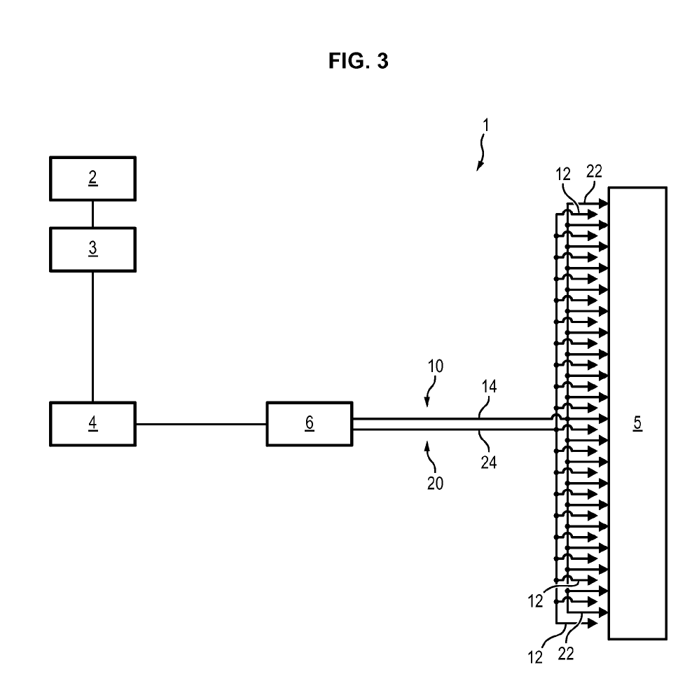

### DETAILED DESCRIPTION OF AN EMBODIMENT

A fuel system 1 comprises, from upstream to downstream in the direction of the fuel flow,

a fuel tank 2,

a high-pressure pump 3 adapted for pressurize fuel from the tank 2, and

a fuel metering unit 4, fed with fuel by the high-pressure pump 3 and adapted to meter the quantity of fuel to the combustion chamber 5 by means of a fuel supply circuit.

The fuel supply circuit here comprises a type of injector comprising two fuel circuits 10, 20 and having therefore two fuel inlets 12, 22, each connected to supply pipes 14, 24.

More precisely, the supply circuit comprises a pilot circuit 10, adapted for injecting fuel continuously into the combustion chamber 5 by means of pilot injectors 12, and a main circuit 20 adapted to intermittently inject fuel in the combustion chamber 5 by means of main injectors 22. The rate of the pilot 10 and main 20 circuits is regulated by means of a rate division valve 6, arranged between the metering unit 4 and the pilot 12 and main 22 injectors. The rate division valve adjusts the rate distribution between each supply circuit as a function of the laws of operability of the turbine engine.

To limit, or even prevent coking of fuel likely to stagnate in the pipes of the main injectors 22, the invention proposes transferring some of the thermal energy from the main injection pipe to the pilot pipe by using the pilot pipe 14 as cold source. For this purpose, the invention proposes confining a thermal conductor 30 between the pilot pipe 14 and the main pipe 24, the thermal conductor 30 being configured to direct the thermal flow from the main pipe 24 to the pilot pipe 14.

Confining, means that the thermal conductor 30 is housed between the two pipes without being able to easily escape. As a consequence, the heat from the main pipe 24 is directed via thermal conduction by means of the thermal conductor 30 to the pilot pipe 14, the temperature of which is lower. The heat of the main pipe 24 therefore does not simply dissipate in the ambient air.

The thermal conductor 30 can extend over all or part of the main 24 and pilot 14 pipes between the metering unit 4 and the combustion chamber 5. For example, the thermal conductor 30 can extend over the length of the pipes 14, 24 subjected to severe temperatures likely to heat the fuel stagnating in the main pipe 24, or as a variant over part only of this length, or according to another variant discontinuously over this length.

According to a first embodiment, the thermal conductor 30 comprises heat-transfer fluid confined in an envelope 32 placed around the pilot pipe 14 and the main pipe 24.

The envelope 32 can be closed so as to trap the heat-transfer fluid forming the thermal conductor 30. As a variant, in the case of heat-transfer fluid comprising air, the envelope 32 can be open at the faces via which the pilot pipe 14 and the main pipe 24 enter and exit. For example, the envelope 32 can comprise a sleeve threaded onto the pilot and main pipes.

To improve thermal transfer from the main pipe 14 to the pilot pipe 24, the envelope 32 can be made of insulating material. Typically, the insulating material can comprise MIN-K®. It is clear of course that the thickness of the envelope 32 depends on its inherent material and on thermal conduction necessary for sufficiently limiting the rise in temperature in the main pipe 24. For example, the envelope 32 can have a thickness comprised between around 1 mm and around 40 mm, preferably between 1 mm and 10 mm, for example of the order of 1 to 3 mm, typically 3 mm. An envelope 32 comprising MIN-K® and having a thickness of the order of 3 mm for example forms a good compromise in terms of thickness (small bulk) and ensures satisfactory thermal insulation.

According to a second embodiment, the thermal conductor 30 can comprise material thermally conductive in the solid state (as compared to fluid). In this embodiment, it is therefore the thermally conductive material which allows the heat to pass from the main pipe 24 to the pilot pipe 14.

Preferably, the thermal conductivity of the thermally conductive material is greater than that of air. Also, the thermally conductive material of the thermal conductor has a melting temperature greater than the temperature which can be achieved by the air surrounding the pipes 14, 24 so that the thermal conductor does not melt in use.

For example, the thermal conductor 30 can comprise rubber, or any type of elastomer. The thermal conductor 30 can typically comprise silicone of the type of silicones typically used in aeronautics and having thermal conductivity of the order of 0.2 W/m.K (i.e., seven times greater than the thermal conductivity of air). As a variant, a specific silicone can also be possible, such as silicone loaded with metallic particles, to further improve the thermal conductivity of the thermal conductor 30.

The thickness of the thermal conductor 30 between the main pipe 24 and the pilot pipe 14 depends on its inherent material as well as the thermal conduction necessary for sufficiently limiting the rise in temperature in the main pipe 24. Typically, the thickness of the thermal conductor can be comprised between 4 mm and 10 mm. In the case of a thermal conductor 30 comprising rubber, the thermal conductor 30 can form a rubber blade having a thickness of the order of 8 mm.

In this embodiment, the solid thermal conductor 30 is housed between the pilot pipe 14 and the main pipe 24. To ensure transfer of thermal flow from the main pipe 24 to the pilot pipe 14, the thermal conductor 30 is preferably in contact with said pipes.

By comparison with the first embodiment, the distance between the two pipes can be reduced, improving transfer of the thermal flow between the main pipe 24 and the pilot pipe 14. In fact, by using a heat-transfer fluid such as air as thermal conductor 30, sufficient distance between the main pipe 24 and the pilot pipe 14 preferably must be maintained to prevent the latter from colliding when subjected to strong vibrations, which could damage them. By contrast, using a thermal conductor 30 in the solid state prevents any of these shocks. Damping of these shocks is also particularly effective when the thermal conductor 30 is elastically deformable, which is the case with rubber or silicone.

Optionally, to slow down heating of the pipes 14, 24, the thermal conductor 30 in the solid state can be housed in an insulating envelope 32 similar in shape, composition and as a function to the insulating envelope 32 of the first embodiment. The insulating envelope 32 can be adjusted to the thermal conductor 30 so as to enclose the thermally conductive material only. As a variant, a space between the thermal conductor 30 in the solid state and the insulating envelope 32 can be made to also confine air in the insulating envelope 32.

Alternatively, in particular when the thermal conductor 30 comprises elastomer, the latter can be confined between the pilot pipe 14 and the main pipe 24 and fixed mechanically to said pipes 14, 24, for example by adhesion. If needed, the thermal conductor 30 can be compressed between said pipes 14, 24. In this variant embodiment, the thermal conductor cannot be housed in an insulating envelope.

Also, the thermal conductor 30 can be selected so as to have thermal conductivity greater than that of air, in which case adding such an envelope formed from insulating material 32 cannot be necessary to prevent a rise in temperature of fuel stagnating in the main pipe 24. This is especially the case of rubber which conducts heat ten times better than air.

So when the main 24 and pilot 14 pipes are spouting at the same time, for example when the turbine engine is in cruise mode, the temperature of fuel in the main pipe 24, in the pilot pipe 14, in the thermal conductor 30 and if needed in the insulating envelope 32 are homogeneous and equal.

But when the main pipe 24 is not spouting, for example during a startup phase of the turbine engine, the thermal flows at the main pipe 24, the pilot pipe 14 and the thermal conductor 30 are the following:

### Convective Flow Φ_{Cv} of External Air to the Insulating Envelope 32:

φ_{Cx}=α(Tₑₓₜₑᵣₙₐₗ−T_{insulating})×Sₑₓₜₑᵣₙₐₗ

where α is the exchange coefficient of external air, Tₑₓₜₑᵣₙₐₗ is the temperature of air outside the insulating envelope 32, T_{insulating} is the temperature of the insulating envelope 32 and Sₑₓₜₑᵣₙₐₗ is the exchange surface between the insulating envelope 32 and external air.

Convective Flow φₚ_{_}ᵢ from the Pilot Pipe 14 to the Insulating Envelope 32:

$${φ}_{p\_i} = {λ}_{i} \frac{( {T}_{pilot} - {T}_{insulting} ) \times {S}_{pilot\_contact}}{{e}_{insulating}} =$$

where λᵢ is the thermal conductivity of the material making up of the insulating envelope 32, Tₚᵢₗₒₜ is the temperature of the pilot pipe 14, Sₚᵢₗₒₜ_{_}_{contact} is the contact surface between the pilot pipe 14 and the insulating envelope 32 and e_{insulating} is the thickness of the insulating envelope 32.

Conductive FlowΦₘ_{_}ᵢ from the Main Pipe 24 to the Insulating Envelope 32:

$${φ}_{m \_i} = {λ}_{i} \frac{( {T}_{main} - {T}_{insulting} ) \times {S}_{main \_contact}}{{e}_{insulating}}$$

where Tₘₐᵢₙ is the temperature of the main pipe 24 and Sₘₐᵢₙ_{_}_{contact} is the contact surface between the main pipe 24 and the insulating envelope 32.

The sum of the conductive flows Φₚ_{_}ᵢ, Φₘ_{_}ᵢ, of the convective flow Φ_{Cv} and of the conductive flow inside the insulating gives the total flow of heat to the insulating envelope 32.

Conductive Flow Φ_{cond} from the Main Pipe 24 to the Pilot Pipe 14 via the Thermal Conductor 30:

$${φ}_{cond} = {λ}_{cond} \frac{( {T}_{main} - {T}_{pilot} ) \times {S}_{cond}}{{e}_{cond}}$$

where λ_{cond} is the thermal conductivity linked to the thermal conductor 30 (heat-transfer fluid or thermal conductor 30 in the solid state), S_{cond} is the contact surface with the main pipe 24 and the pilot pipe 14, and e_{cond} is the thickness of the thermal conductor 30.

Conductive Flow Φᵢ_{_}ₚ from the Insulating Envelope 32 to the Pilot Pipe 14

$${φ}_{i \_p} = - {λ}_{i} \frac{( {T}_{pilot} - {T}_{insulting} ) \times {S}_{pilot\_contact}}{{e}_{insulating}}$$

The sum of the conductive flows Φ_{cond} and Φᵢ_{_}ₚ gives the total flow of heat received by the pilot pipe 14.

Conductive Flow Φᵢ_{_}ₚ from the Insulating Envelope 32 to the Main Pipe 24

$${φ}_{i \_m} = - {λ}_{i} \frac{( {T}_{main} - {T}_{insulting} ) \times {S}_{pilot \_contact}}{{e}_{insulating}}$$

The sum of the conductive flows Φ_{cond} and Φᵢ_{_}ₘ gives the total flow of heat received by the main pipe 24.

Given the specific heats of the different elements as well as the transiting flow, the temperature of fuel stagnating in the main pipe 24 therefore rises much more slowly when the fuel system comprises a thermal conductor 30 confined between the main pipe 24 and the pilot pipe 14 than when it is devoid thereof. In fact, a substantial part of the thermal flow entering the assembly formed by the thermal conductor 30, the main pipe 24 and the pilot pipe 14 is transferred by conduction to the pilot pipe 14 via the thermal conductor 30 and if needed the envelope 32, since it is the pilot pipe 14 which constitutes the coldest point of the assembly. By comparison, without thermal conductor 30 or when the main pipe 24 is thermally insulated from the rest of the fuel system 1 (for example by means of an insulating sleeve threaded onto the main pipe 24 only), the entire thermal flow passing through the insulating sleeve is directed to the main pipe 24 and consequently heats much more the fuel stagnating therein.

Examples of the fuel system 1 comprising a thermal conductor 30 confined between a main pipe 24 and a pilot pipe 14 and housed in an insulating envelope 32 of MIN-K® of thickness 30 mm will be described hereinbelow.

In these examples, the environment of the fuel system 1 is substantially stabilized with an external temperature of the order of 193° C. and a temperature of fuel spouting in the pilot pipe 14 of the order of 145° C. Also, the exchange coefficient of external air a is of the order of 23 W/m²/K and the thermal conductivity λᵢ of the material making up the insulating envelope 32 of the order of 0.05 W/m.K.

In a first example, the thermal conductor 30 comprises air enclosed in the insulating envelope. The thermal convective flow Φ_{Cv} of external air to the external surface of the insulating envelope 32 is of the order of 9 W.

Distribution of the thermal flow in the pilot pipe 14 and in the main pipe 24 is around 8.99 W in the pilot pipe 14 for 0.01 W in the main pipe 24, and this even though the two pipes 14, 24 are symmetrical.

In a second example, the thermal conductor 30 comprises a rubber blade of thickness 8 mm enclosed in the insulating envelope. In this example, the insulating envelope 32 is adjusted on the rubber blade 30, without the presence of air. The convective thermal flow Φ_{Cv} of external air to the external surface of the insulating envelope 32 is of the order of 11 W.

Distribution of the thermal flow in the pilot pipe 14 and in the main pipe 24 is around 11.8 W in the pilot pipe 14 for 0.02 W in the main pipe 24.

In this way, irrespective of the embodiment, a large part of the thermal flow which would have been directed to the main pipe 24 and therefore reheat it is in fact transferred to the pilot pipe 14 by way of the air 30 confined between the two pipes 14, 24 in the insulating envelope 32, the air 30 and the insulating envelope 32 enabling conduction of heat from the main pipe 24 to the pilot pipe 14.

Therefore, fuel likely to stagnate in the main pipe 24 stays under 150° C. even though the external air is at 193° C., and this even after thirty minutes. The thermal conductor 30 and if needed the insulating envelope 32 therefore significantly slow down the fuel heating speed likely to stagnate in the main pipe 24 and consequently prevent its heating beyond a set temperature favouring the formation of coke.

By way of comparison, without thermal conductor 30 and by simply thermally protecting the main pipe 24 from the rest of the fuel system 1 with a sleeve having the same properties as the insulating envelope 32, with the same conditions of external temperature and initial fuel temperature in the main pipe 24, the temperature of fuel stagnating in the main pipe 24 rises to around 165° C. after thirty minutes.

The advantage of using a thermal conductor 30 confined between the main pipe 24 and the pilot pipe 14 is not having to add an additional system to conduct purging and eliminates the considerable restrictions necessary for managing this purged fuel. It also cleverly uses the fuel flow for cooling the flow stagnating in the main pipes, without adding extra equipment (heat exchanger type). The insulating used (MIN-K® is also light and not bulky, simplifying its application.

1. A fuel system for a turbine engine, adapted for injecting fuel in a combustion chamber of the turbine engine, comprising:
a pilot circuit, adapted for injecting fuel in the combustion chamber by means of a pilot pipe,
a main circuit, adapted for injecting fuel in the combustion chamber by means of a main pipe,
the fuel system being characterized in that it further comprises a thermal conductor confined between the pilot pipe and the main pipe and configured to direct the thermal flow from the main pipe to the pilot pipe, the thermal conductor being housed in an envelope formed of insulating material, said envelope being placed around the pilot pipe and the main pipe.

2. The fuel system according to claim 1, wherein the insulating material can have a thickness comprised between around 1 mm and around 40 mm, preferably between 1 mm and 10 mm, for example of the order of 3 mm.

3. The fuel system according to claim 1, wherein the thermal conductor comprises heat-transfer fluid.

4. The fuel system according to claim 3, wherein the heat-transfer fluid is air.

5. The fuel system according to claim 1, wherein the thermal conductor comprises thermally conductive material in the solid state.

6. The fuel system according to claim 5, wherein the thermally conductive material has thermal conductivity greater than that of air.

7. The fuel system according to claim 5, wherein the thermally conductive material comprises rubber or an elastomer, such as silicone.

8. The fuel system according to claim 1, wherein the thermal conductor extends over all or part of the length of the main pipe upstream of the combustion chamber.

9. A turbine engine comprising a combustion chamber and a fuel system according to claim 1.

10. A fuel system for a turbine engine, adapted for injecting fuel in a combustion chamber of the turbine engine, comprising:
2. a pilot circuit, adapted for injecting fuel in the combustion chamber by means of a pilot pipe,
3. a main circuit, adapted for injecting fuel in the combustion chamber by means of a main pipe,
the fuel system being characterized in that it further comprises a thermal conductor confined between the pilot pipe and the main pipe and configured to direct the thermal flow from the main pipe to the pilot pipe, the thermal conductor being housed in an envelope formed in insulating material, said envelope being placed around the pilot pipe and the main pipe,
wherein the thermal conductor comprises thermally conductive material in the solid state having thermal conductivity greater than that of air, said thermally conductive material comprising rubber or elastomer.

11. The fuel system according to claim 10, wherein the thermally conductive material comprises silicone.
